(19) United States
(12) Patent Application Publication
(10) Pub. No.: US 2001/0040545 A1
(43) Pub. Date: Nov. 15, 2001

(54) Liquid crystal display device

(75) Inventors: Yasuyuki Mishima, Mobara (JP); Yoshio Oowaki, Mobara (JP)

Correspondence Address: Stanley P. Fisher, Reed Smith Hazel & Thomas LLP, 3110 Fairview Park Drive, Suite 1400, Falls Church, VA, 22042-4503, US

(73) Assignee: Hitachi, Ltd. and Hitachi Device Engineering Co., Ltd.

(21) Appl. No.: 09/851,943

(22) Filed: May 10, 2001

(30) Foreign Application Priority Data
May 12, 2000 (JP) 2000-140959

(51) Int. Cl. G09G 3/36

(52) U.S. Cl. 345/87

(57) ABSTRACT

There is provided a liquid crystal display device capable of decreasing the amount of generation of radiation electromagnetic noise. The liquid crystal display device includes plural driving circuits, a display control device which transmits display data and a clock signal to the plural driving circuits, and a circuit board, and supplies the display data and the clock signal transmitted from the display control device, to each of the driving circuits via a bus line and a clock signal line in the circuit board. Each of the bus line and the clock signal line is formed in a continuous area of the circuit board and is divided into plural lines. The display control device supplies the display data and the clock signal to each of the divided bus lines and clock signal lines in sequence in accordance with transmission timing.

### BACKGROUND OF THE INVENTION

1. Field of the Invention

The present invention relates to a liquid crystal display device and, more particularly, to an art useful for application to a driving circuit of the liquid crystal display device.

2. Description of the Related Art

An STN (Super Twisted Nematic) or TFT (Thin Film Transistor) type of liquid crystal display module is widely used as a display device for a notebook type of personal computer.

The TFT type of liquid crystal display device includes a liquid crystal display panel, a driving circuit for driving the liquid crystal display panel (drain drivers and gate drivers), a display control device (or a timing controller) and a power source circuit.

Incidentally, such a liquid crystal display device is described in, for example, Japanese Patent Laid-Open No. 71328/1997.

### SUMMARY OF THE INVENTION

In the TFT type of liquid crystal display device, a picture is displayed on the liquid crystal display panel by applying gray scale voltages corresponding to display data to its respective pixels via the driver drivers disposed in the longer-length (or horizontal) direction of the liquid crystal display device and the gate drivers disposed in the shorter-length (or longitudinal) direction of the liquid crystal display device.

Accordingly, the drain drivers need to acquire in advance the display data in synchronism with a clock signal for latching display data.

In recent years, in the field of liquid crystal display devices, to meet the demand for a further increase in the screen size of a liquid crystal display panel, the liquid crystal display panel has been required to have a far higher resolution such as 1024×768 pixels in XGA display mode, 1280×1024 pixels in SXGA display mode or 1600×1200 pixels in UXGA display mode.

As the resolution of the liquid crystal display panel becomes higher in this manner, the number of drain drivers becomes larger, and the time to acquire display data into each of the drain drivers becomes shorter and furthermore, the frequency of the clock signal for latching display data increases.

On the other hand, regarding an information apparatus such as a personal computer, the amount of generation of radiation electromagnetic noise generated from the information apparatus is restricted.

However, for the above and other reasons, there is the problem that as the frequency of the clock signal becomes higher, the radiation electromagnetic noise generated from the liquid crystal display device becomes larger.

In addition, as described above, if the frequency of the clock signal for latching display data becomes higher and the time to acquire display data becomes shorter, waveform distortion occurs in the display data and the display-data-latching clock signal transmitted from the display control device owing to the internal resistance, the internal inductance and the internal parasitic capacitance of a circuit board provided between the display control device and each of the drain drivers as well as the input capacitance of each of the drain drivers. This leads to the problem that display data cannot be accurately acquired during the acquisition of the display data into each of the drain drivers. The invention has been made to solve the problems of the related art, and provides an art which can decrease the amount of generation of radiation electromagnetic noise in a liquid crystal display device.

In addition, the invention provides an art which enables display data to be accurately acquired into each driving circuit in a liquid crystal display device using a high-resolution liquid crystal display element.

The above and other novel objects and features of the invention will become apparent from the following description taken in conjunction with the accompanying drawings.

Representative aspects of the invention disclosed herein will be described below in brief.

A liquid crystal display device includes a liquid crystal display element, plural driving circuits, a display control device which transmits display data and a clock signal to the plural driving circuits, and a circuit board which supplies the display data and the clock signal transmitted from the display control device, to each of the driving circuits via a bus line and a clock line in the circuit board. Each of the bus line and the clock signal line of the circuit board is formed in a continuous area of the circuit board and is divided into plural lines.

In an embodiment of the invention, the display control device supplies the display data and the clock signal to each of the divided bus lines and clock signal lines in sequence in accordance with transmission timing.

In an embodiment of the invention, the display control device supplies a signal of fixed voltage level to each of the divided bus lines and clock signal lines in sequence in accordance with transmission timing.

In an embodiment of the invention, each of the bus line and the clock signal line of the circuit board is divided into two lines.

In an embodiment of the invention, the display control device sequentially supplies the display data and the clock signal to one of the bus lines and one of the clock signal lines and to the other of the bus lines and the other of the clock signal lines in accordance with transmission timing.

In an embodiment of the invention, while the display control device is supplying the display data and the clock signal to one of the bus lines and one of the clock signal lines, the display control device supplies signals of fixed voltage level to the other of the bus lines and the other of the clock signal lines.

The invention also provides a liquid crystal display device which includes a liquid crystal display element, plural driving circuits, a display control device which transmits display data and a clock signal to the plural driving circuits, and a circuit board which is provided between the display control device and the plural driving circuits and supplies the display data and the clock signal transmitted from the display control device, to each of the driving circuits via a bus line and a clock line in the circuit board. Each of the bus line and the clock signal line of the circuit board is formed in a continuous area of the circuit board and is divided into plural lines, and a connector for inputting the display data and the clock signal from the display control device is provided in a portion other than a lengthwise end portion of the circuit board.

According to the above-described construction, since each of the bus line and the clock signal line in the circuit board is divided into two lines and the display control device supplies the display data and the clock signal to one of the two bus lines and one of the two clock signal lines and also supplies the signals of fixed voltage level to the other of the two bus lines and the other of the two clock signal lines, the amount of generation of radiation electromagnetic noise can be reduced.

In addition, according to the above-described construction, the internal parasitic capacitance, the internal resistance and the internal inductance of the circuit boards and the input capacitance of each of the driving circuits can be decreased, and even in the case of a high-resolution liquid crystal display panel in which the transfer frequency of display data and the frequency of a clock signal are high, a signal waveform having a predetermined amplitude and phase can be acquired by the driving circuits.

### BRIEF DESCRIPTION OF THE DRAWINGS

Preferred embodiments of the invention will be described in detail with reference to the following figures, wherein:

FIG. 1 is a block diagram showing the schematic construction of a TFT type of liquid crystal display module according to one embodiment of the invention;

FIG. 2 is a view showing the equivalent circuit of one example of the liquid crystal display panel shown in FIG. 1;

FIG. 3 is a view showing the equivalent circuit of another example of the liquid crystal display panel shown in FIG. 1;

FIG. 4 is a block diagram showing the schematic construction of one example of the drain drivers shown in FIG.

FIG. 5 is a block diagram for explaining the construction of the drain driver shown in FIG. 4 as well as the construction of an output circuit;

FIG. 6 is a block diagram showing the construction of each circuit board of the liquid crystal display module according to one embodiment of the invention;

FIG. 7 is a view showing the equivalent circuit of the circuit board of one embodiment of the invention;

FIG. 8 is a view showing the output waveforms of display data DATA and a clock signal CL2 outputted to the circuit board from the display control device of one embodiment of the invention;

FIG. 9 is a view showing the output waveforms of the display data DATA and the clock signal CL2 inputted to a drain driver of one embodiment of the invention;

FIG. 10 is a block diagram showing the construction of each circuit board of a liquid crystal display module according to another embodiment of the invention;

FIG. 11 is a block diagram showing the construction of each circuit board of a liquid crystal display module according to another embodiment of the invention;

FIG. 12 is a block diagram showing the construction of a circuit board in a related art liquid crystal display module;

FIG. 13 is a view showing the equivalent circuit of the circuit board shown in FIG. 12;

FIG. 14 is a view showing the output waveforms of the display data DATA and the clock signal CL2 outputted to the circuit board from the display control device shown in FIG. 12; and

FIG. 15 is a view showing the output waveforms of the display data DATA and the clock signal CL2 inputted to the drain drivers shown in FIG. 12.

### DESCRIPTION OF THE PREFERRED EMBODIMENTS

Preferred embodiments of the present invention will be described below in detail with reference to drawings which show the embodiments.

In all the drawings to be used for explaining preferred embodiments, parts having the same functions are denoted by the same reference numerals, and the repetitive descriptions of the same parts are omitted.

<Embodiment 1>

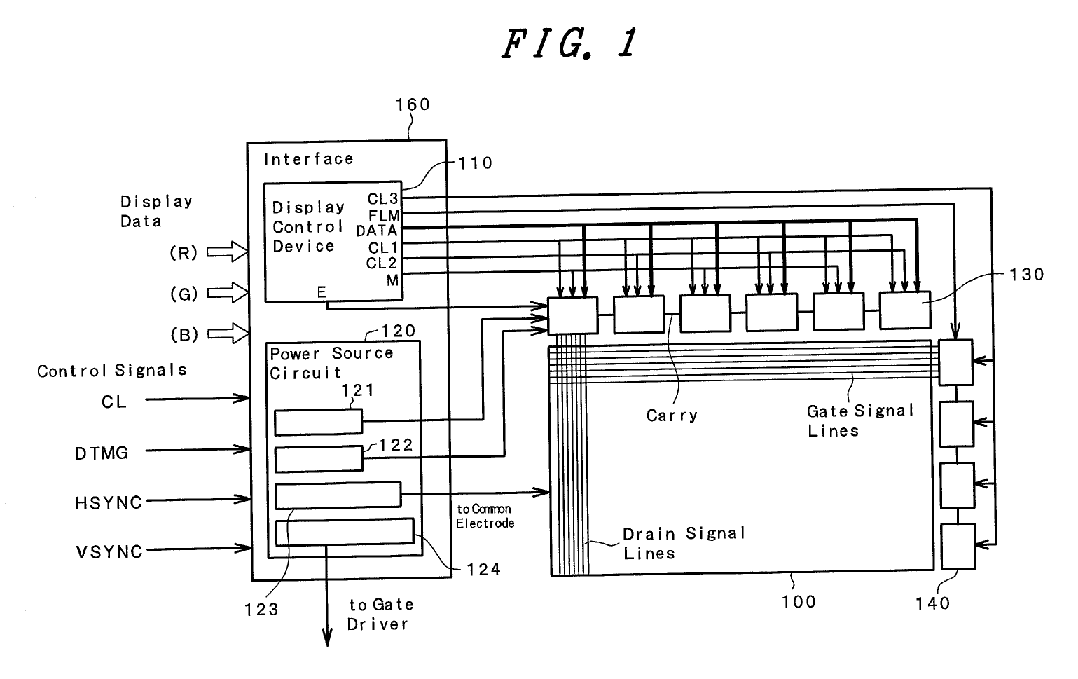

FIG. 1 is a block diagram showing the schematic construction of a TFT type of liquid crystal display module according to Embodiment 1 of the invention.

In the liquid crystal display module according to Embodiment 1, drain drivers 130 are disposed along one longer side of a liquid crystal display panel (TFT-LCD) 100, while gate drivers 140 are disposed along one shorter side of the liquid crystal display panel 100.

An interface part 160, the drain drivers 130 and the gate drivers 140 are respectively mounted on dedicated printed circuit boards.

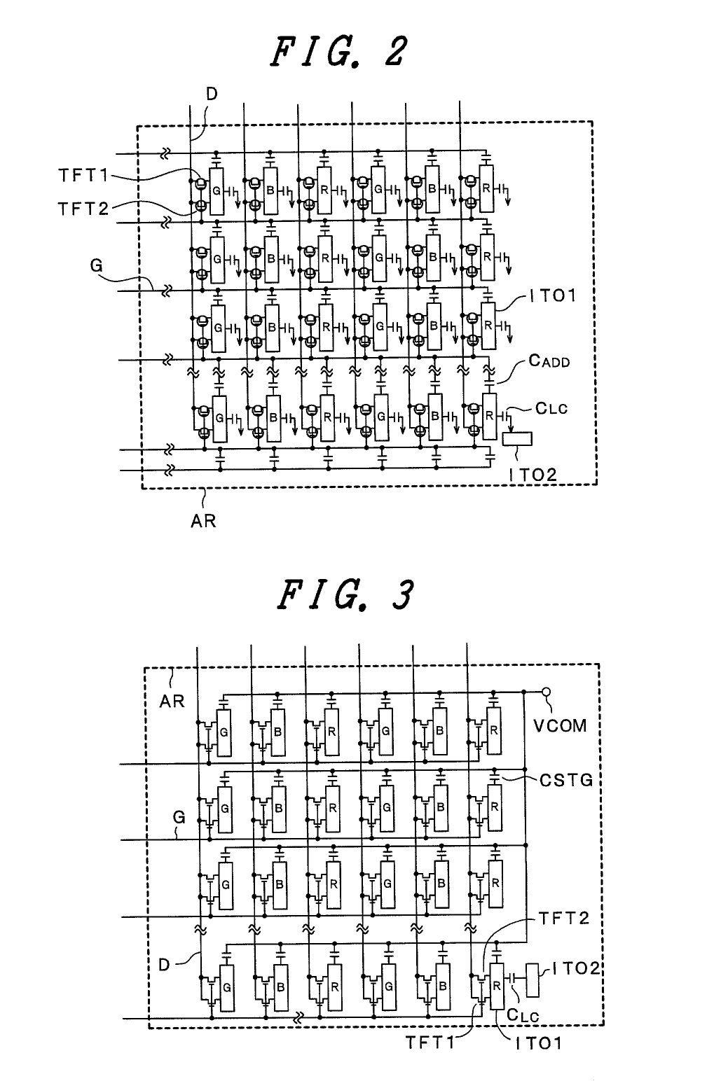

FIG. 2 is a view showing the equivalent circuit of one example of the liquid crystal display panel 100 shown in FIG. 1.

As shown in FIG. 2, the liquid crystal display panel 100 has plural pixels formed in matrix form.

Each of the pixels is disposed in the area of intersection of two adjacent signal lines (drain signal lines D or gate signal lines G) and two adjacent signal lines (gate signal lines G or drain signal lines D).

Each of the pixels has thin film transistors TFT1 and TFT2 and the source electrodes of the thin film transistors TFT1 and TFT2 of each of the pixels are connected to a pixel electrode ITO1. Since a liquid crystal layer is disposed between the pixel electrode ITO1 and a common electrode IT02, a liquid crystal capacitance CLC is equivalently connected between the source electrodes of the thin film transistors TFT1 and TFT2 and the common electrode ITO2.

An added capacitance Cadd is connected between the source electrodes of the thin-film transistors TFT1 and TFT2 and the front-stage one of the two adjacent gate signal lines G.

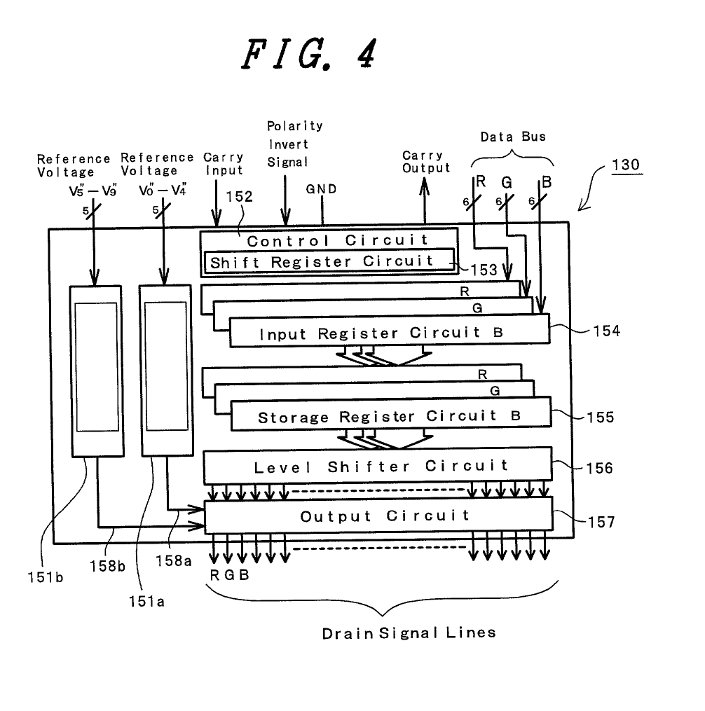

FIG. 3 is a view showing the equivalent circuit of another example of the liquid crystal display panel 100 shown in FIG. 1.

In the example shown in FIG. 2, the added capacitance Cadd is formed between the front-stage gate signal line G and the source electrodes, whereas in the equivalent circuit of the example shown in FIG. 3, a holding capacitance CSTG is formed between the source electrodes and a common signal line COM to which to apply a voltage VCOM to be supplied to the common electrode ITO2.

In each of FIGS. 2 and 3, symbol AR denotes a display area.

The invention can be applied to either of the examples. In the former scheme, a pulse on the front-stage gate signal line G may penetrate into the pixel electrode ITO1 through the added capacitance Cadd, but in the latter scheme, since such penetration does not occur, a far better display is enabled.

FIGS. 2 and 3 show the equivalent circuits of liquid crystal display panels of the vertical electric field type, and also are circuit diagrams which are drawn to correspond to actual geometric arrangements, respectively.

In each of the liquid crystal display panels 100 shown in FIGS. 2 and 3, the drain electrodes of the respective thin film transistors TFT1 and TFT2 of each of the pixels which are disposed in the column direction are connected to the adjacent one of the drain signal lines D, and each of the drain signal lines D is connected to the corresponding one of the drain drivers 130 for supplying gray scale voltages to the liquid crystal in the corresponding ones of the pixels disposed in the column direction.

The gate electrodes of the respective thin film transistors TFT1 and TFT2 of each of the pixels which are disposed in the row direction are connected to the adjacent one of the gate signal lines G, and each of the gate signal lines G is connected to the corresponding one of the gate drivers 140 for supplying, for one horizontal scanning period, scanning driving voltages (positive bias voltages or negative bias voltages) to the gate electrodes of the thin film transistors TFT1 and TFT2 of the corresponding ones of the pixels disposed in the row direction.

The interface block 160 shown in FIG. 1 includes a display control device 110 and a power source circuit 120.

The display control device 110 is made of one semiconductor integrated circuit (LSI), and controls and drives the drain drivers 130 and the gate drivers 140 on the basis of display control signals such as clock signals (CL), display timing signals (DTMG), horizontal synchronizing signals (HSYNC) and vertical synchronizing signals (VSYNC) as well as display data (R, G and B) all of which are to be transmitted from a video signal source such as a computer host.

When the display control device 110 receives a display timing signal, the display control device 110 determines that this signal indicates a display start position, and outputs a single line of received display data to the drain drivers 130 via a bus line for display data.

At this time, the display control device 110 outputs via a signal line a display data latching clock CL2 (hereinafter referred to simply as the clock signal CL2) which is a display control signal for latching display data into the data latch circuit of each of the drain drivers 130.

The display data transmitted from the host computer is 6- or 8-bit data, and is transmitted by one pixel at a time, i.e., one set of red (R), green (G) and blue (B) data at a time, at intervals of a unit time period.

At this time, the display control device 110 outputs via a signal line a display data latching clock signal CL2 (hereinafter referred to simply as the clock signal CL2) which is a display control signal for latching display data into the data latch circuit of each of the drain drivers 130.

The display data transmitted from the host computer is 6- or 8-bit data, and is transmitted by one pixel at a time, i.e., one set of red (R), green (G) and blue (B) data at a time, at intervals of a unit time period.

When the inputting of the display timing signal is completed or a predetermined time period passes after the display timing signal has been inputted, the display control device 110 determines that one horizontal line of display data has been completed, and outputs, to each of the drain drivers 130 via a signal line, an output timing control clock signal CL1 (hereinafter referred to simply as the clock signal CL1) which is a display control signal for outputting the display data stored in the data latch circuit of each of the drain drivers 130 to the drain signal lines D of the liquid crystal display panel 100.

When the first display timing signal is inputted to the display control device 110 after the inputting of a vertical synchronizing signal, the display control device 110 determines that this signal indicates the first display line, and outputs a frame start indication signal FLM to the gate drivers 140 via a signal line.

In addition, the display control device 110 outputs a shift clock signal CL3 having the cycle of one horizontal scanning period (hereinafter referred to simply as the clock signal CL3) to the gate drivers 140 via a signal line so that a positive bias voltage is sequentially applied to each of the gate signal lines G of the liquid crystal display panel 100 at intervals of one horizontal scanning period on the basis of a horizontal synchronizing signal.

In this manner, plural thin film transistors TFT1 and TFT2 which are connected to each of the gate signal lines G of the liquid crystal display panel 100 are turned on for one horizontal synchronizing period.

By the above-described operation, a picture is displayed on the liquid crystal display panel 100.

The power source circuit 120 shown in FIG. 1 is made of a positive voltage generation circuit 121, a negative voltage generation circuit 122, a common electrode (counter electrode) voltage generation circuit 123 and a gate electrode voltage generation circuit 124.

Each of the positive voltage generation circuit 121 and the negative voltage generation circuit 122 is made of a series resistance voltage dividing circuit, and the positive voltage generation circuit 121 outputs a five-level gray scale reference voltage (V″0 to V″4) of positive polarity, while the negative voltage generation circuit 122 outputs a five-level gray scale reference voltage (V″5 to V″9) of negative polarity.

The gray scale reference voltage (V″0 to V″4) of positive polarity and the gray scale reference voltage (V″5 to V″9) of negative polarity are respectively supplied to the drain drivers 130.

In addition, an alternation signal (alternation timing signal; M) from the display control device 110 is supplied to each of the drain drivers 130.

The common electrode voltage generation circuit 123 generates a driving voltage to be applied to the common electrode ITO2, while the gate electrode voltage generation circuit 124 generates a driving voltage (a positive bias voltage or a negative bias voltage) to be applied to the gate electrodes of the thin film transistors TFT1 and TFT2.

FIG. 4 is a block diagram showing the schematic construction of one example of the drain drivers 130 shown in FIG. 1.

The shown drain driver 130 is made of one semiconductor integrated circuit (LSI).

In FIG. 4, letting n be the number of bits of display data, a positive gray scale voltage generation circuit 151a generates a 2ⁿ-level gray scale voltage of positive polarity on the basis of the five-level gray scale reference voltage (V″0 to V″4) of positive polarity inputted from the positive voltage generation circuit 121, and outputs the 2ⁿ-level gray scale voltage to an output circuit 157 via a voltage bus line 158a.

A negative gray scale voltage generation circuit 151b generates a 2ⁿ-level gray scale voltage of negative polarity on the basis of the five-level gray scale reference voltage (V″5 to V″9) of negative polarity inputted from the negative voltage generation circuit 122, and outputs the 2ⁿ-level gray scale voltage to the output circuit 157 via a voltage bus line 158b.

A shift register circuit 153 included in a control circuit 152 of the drain driver 130 generates a data acquisition signal for an input register circuit 154 and outputs the data acquisition signal to the input register circuit 154, on the basis of the clock signal CL2 inputted from the display control device 110.

The input register circuit 154 latches display data of n bits for each color by the number of output terminals in synchronism with the clock signal CL2 inputted from the display control device 110, on the basis of the data acquisition signal outputted from the shift register circuit 153.

A storage register circuit 155 latches the display data stored in the input register circuit 154, according to the output timing control clock signal CL1 inputted from the display control device 110.

The display data acquired into the storage register circuit 155 is inputted to the output circuit 157 via a level shift circuit 156.

The output circuit 157 selects one gray scale voltage level corresponding to the display data from the 2ⁿ-level gray scale voltage of positive polarity or the 2ⁿ-level gray scale voltage of negative polarity, and outputs the selected gray scale voltage level to each of the drain signal lines D.

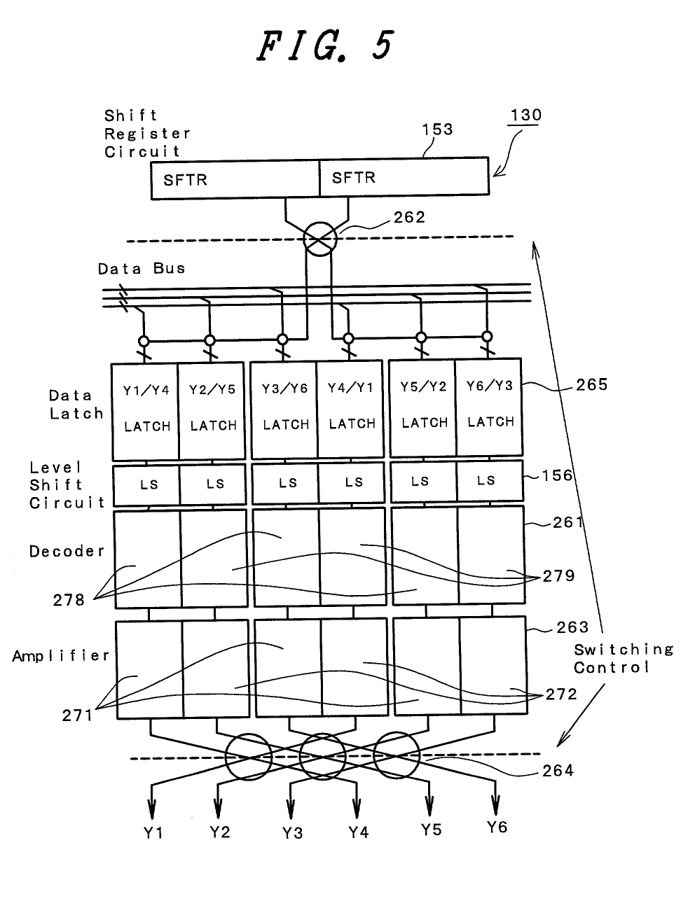

FIG. 5 is a block diagram for explaining the construction of the drain driver 130 shown in FIG. 4, as well as the construction of the output circuit 157.

In general, if the same voltage (DC voltage) is applied to a liquid crystal layer for a long time, the inclination of the liquid crystal layer is fixed, so that an image-retention phenomenon is caused to reduce the life of the liquid crystal layer.

To prevent this problem, in the related art TFT type of liquid crystal display module, AC voltage is applied to the liquid crystal layer.

As a driving method of applying AC voltage to the liquid crystal layer, a common symmetry method such as a dot inversion method or an N-line inversion method are known, and FIG. 5 shows a construction in which the dot inversion method is adopted as a driving method.

In FIG. 5, reference numeral 153 denotes the shift register circuit included in the control circuit 152, and reference numeral 156 denotes the level shift circuit shown in FIG. 4. Data latch parts 265 represent the input register circuit 154 and the storage register circuit 155 that are shown in FIG. 4. In addition, decoder parts (gray scale voltage selection circuits) 261, amplifier circuit pairs 263, and switching parts (2) 264 for switching over the outputs of the amplifier circuit pairs 263 constitute the output circuit 157 shown in FIG. 4.

In this construction, a switching part (1) 262 and the switching parts (2) 264 are controlled on the basis of the alternation signal M.

Symbols Y1, Y2, Y3, Y4, Y5 and Y6 denote, respectively, the first, second, third, fourth, fifth and sixth drain signal lines D.

In the drain driver 130 shown in FIG. 5, the switching part (1) 262 switches over data acquiring signals to be inputted to the data latch parts 265 (more specifically, the input register circuit 154 shown in FIG. 4), thereby inputting display data for each color to the corresponding pair of adjacent ones of the data latch parts 265 for each color.

Each of the decoder parts 261 is made of a high voltage decoder circuit 278 and a low voltage decoder circuit 279. The high voltage decoder circuit 278 selects a gray scale voltage level of positive polarity corresponding to the display data outputted from the corresponding one of the data latch parts 265 (more specifically, the storage register circuit 155 shown in FIG. 4), from the 2ⁿ-level gray scale voltage of positive polarity outputted from the positive gray scale voltage generation circuit 151a via the voltage bus line 158a, whereas the low voltage decoder circuit 279 selects a gray scale voltage level of negative polarity corresponding to the display data outputted from the corresponding one of the data latch parts 265, from the 2ⁿ-level gray scale voltage of negative polarity outputted from the negative gray scale voltage generation circuit 151b via the voltage bus line 158b.

The high voltage decoder circuit 278 and the low voltage decoder circuit 279 are provided in each of the data latch parts 265.

Each of the amplifier circuit pairs 263 is made of a high voltage amplifier circuit 271 and a low voltage amplifier circuit 272.

The gray scale voltage level of positive polarity selected by the corresponding one of the high voltage decoder circuits 278 is inputted to the high voltage amplifier circuit 271, and the high voltage amplifier circuit 271 outputs a gray scale voltage of positive polarity.

The gray scale voltage level of negative polarity selected by the corresponding one of the low voltage decoder circuits 279 is inputted to the low voltage amplifier circuit 272, and the low voltage amplifier circuit 272 outputs a gray scale voltage of negative polarity.

In the dot inversion method, the gray scale voltage of each color is of opposite polarity to the gray scale voltage of the adjacent color, and the arrangement of the high voltage amplifier circuits 271 and the low voltage amplifier circuits 272 of the amplifier circuit pairs 263 is in the order of the high voltage amplifier circuit 271 → the low voltage amplifier circuit 272 → the high voltage amplifier circuit 271 → the low voltage amplifier circuit 272. Data acquiring signals to be inputted to the data latch parts 265 are switched over by the switching part (1) 262, thereby inputting display data for each color to the corresponding pair of adjacent ones of the data latch parts 265 for each color, and according to this input operation, the output voltages from the high voltage amplifier circuits 271 or the low voltage amplifier circuits 272 are switched over by the switching parts (2) 264 and are outputted to the drain signal lines D to which to output gray scale voltages of the respective colors, for example, to the first drain signal line Y1 and the fourth drain signal line Y4. In this manner, a gray scale voltage of positive polarity or negative polarity can be outputted to each of the drain signal lines D.

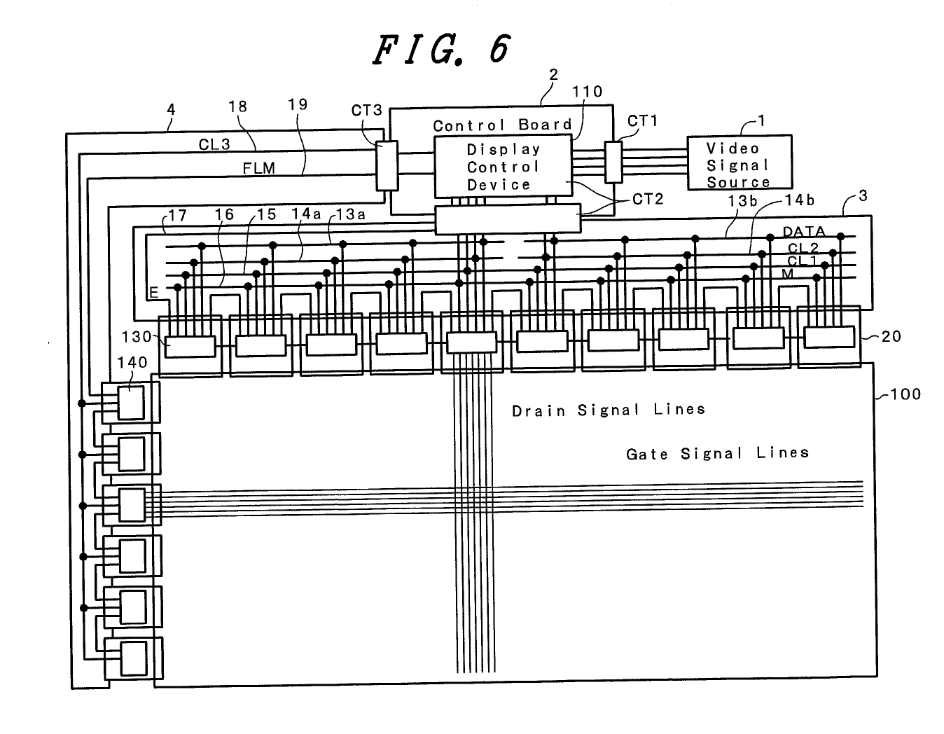

FIG. 6 is a block diagram showing the construction of each circuit board of the liquid crystal display module according to Embodiment 1.

In FIG. 6, reference numeral 1 denotes a video signal source such as a host computer, reference numeral 2 a control board, reference numeral 3 a drain-river-side circuit board, reference numeral 4 a gate-driver-side circuit board, reference numeral 20 a tape carrier package (hereinafter referred to as TCP) on which is mounted a semiconductor chip which constitutes the drain driver 130 or the gate driver 140, and symbols CT1 to CT3 denote connectors.

Each of the circuit boards 3 and 4 is made of, for example, a glass-epoxy printed wiring board or a flexible printed circuit board, and the TCPs 20 and circuit boards 3 and 4 are electrically and mechanically connected by soldering or ACF.

Incidentally, although not shown, the control board 2 is disposed on the reverse side of the liquid crystal display module (on the opposite side to the liquid crystal display panel), and each of the circuit boards 3 and 4 is disposed on a peripheral side of the liquid crystal display panel 100.

The circuit board 3 has a bus line 13a and 13b through which to transfer display data, a signal line 14a and 14b through which to transfer the clock signal CL2, a signal line 15 through which to transfer the clock signal CL1, a signal line 16 through which to transfer the alternation signal M, and a signal line 17 through which to transfer a carry signal E. The circuit board 4 has a signal line 18 through which to transfer the frame start signal FLM and a signal line 18 through which to transfer a clock signal CL3.

Display data from the display control device 110 are inputted to the bus line 13a and 13b of the circuit board 3 via a connector CT2, and are inputted to the respective drain drivers 130 via this bus line 13a and 13b.

Similarly, display control signals from the display control device 110 are inputted to the respective signal lines of the circuit boards 3 and 4 via the connectors CT2 and CT3, and are inputted to the drain driver 130 and the gate driver 140 via the respective signal lines.

Incidentally, in FIG. 6, the bus line 13a and 13b is represented by one line, but actually, plural bus lines are provided by the number of bits of display data for each color (3×n lines, where n represents the number of bits of display data).

Each of the circuit boards 3 and 4 also has signal lines through which to transmit other signals, and power source lines through which to supply a power source voltage and a gray scale reference voltage, but the illustration of these lines is omitted in FIG. 6.

In Embodiment 1, the bus line 13a and 13b and the signal line 14a and 14b of the circuit board 3 are divided into two groups, and the drain drivers 130 are correspondingly divided into two groups.

Display data and the clock signal CL2 are supplied to each of the drain drivers 130 of the first group via the bus line 13a and the signal line 14a, respectively. Display data and the clock signal CL2 are supplied to each of the drain drivers 130 of the second group via the bus line 13b and the signal line 14b, respectively.

In this operation, first, the display control device 110 supplies the display data and the clock signal CL2 to the bus line 13a and the signal line 14a of the circuit board 3, and also supplies signals of fixed voltage level (for example, a low-level signal) to the bus line 13b and the signal line 14b of the circuit board 3.

Then, the display control device 110 supplies the display data and the clock signal CL2 to the bus line 13b and the signal line 14b of the circuit board 3, and also supplies signals of fixed voltage level (for example, a low-level signal) to the bus line 13a and the signal line 14a of the circuit board 3.

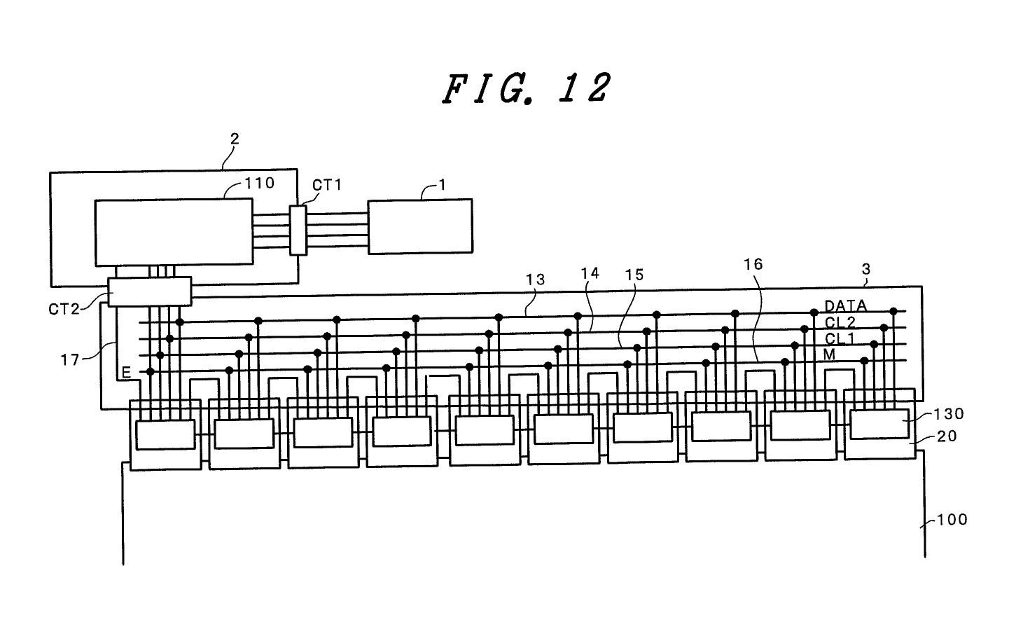

FIG. 12 is a block diagram showing the construction of the circuit board 3 in a related art liquid crystal display module.

As shown in FIG. 12, in the related art liquid crystal display module, each of the bus line 13 and the signal line 14 of the circuit board 3 is made of one line without being divided, and the connector CT2 is provided at one end of the circuit board 3.

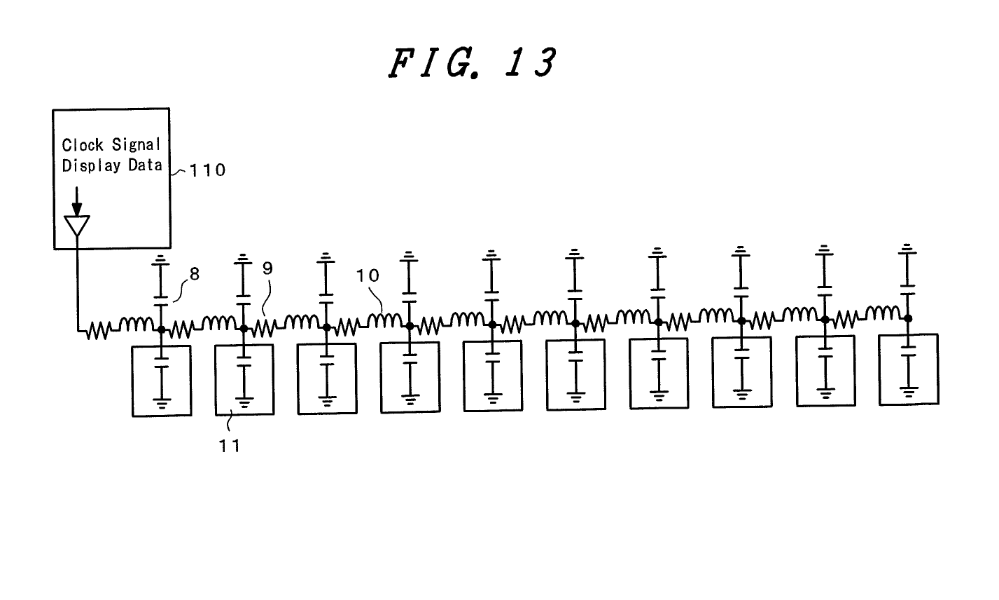

FIG. 13 is a view showing the equivalent circuit of the circuit board 3 shown in FIG. 12.

As shown in FIG. 13, the bus line 13 and the signal line 14 of the circuit board 3 constitute a distributed constant line. In FIG. 13, reference numeral 8 denotes an internal parasitic capacitance between the bus line and the signal line or between a reference potential GND and the bus line and the signal line provided on the circuit board 3, reference numeral 9 denotes the internal resistance of the bus line and the signal line provided on the circuit board 3, reference numeral 10 denotes the internal inductance of the bus line and the signal line provided on the circuit board 3, and reference numeral 11 denotes the input impedance (in this example, input capacitance) of each of the drain drivers 130.

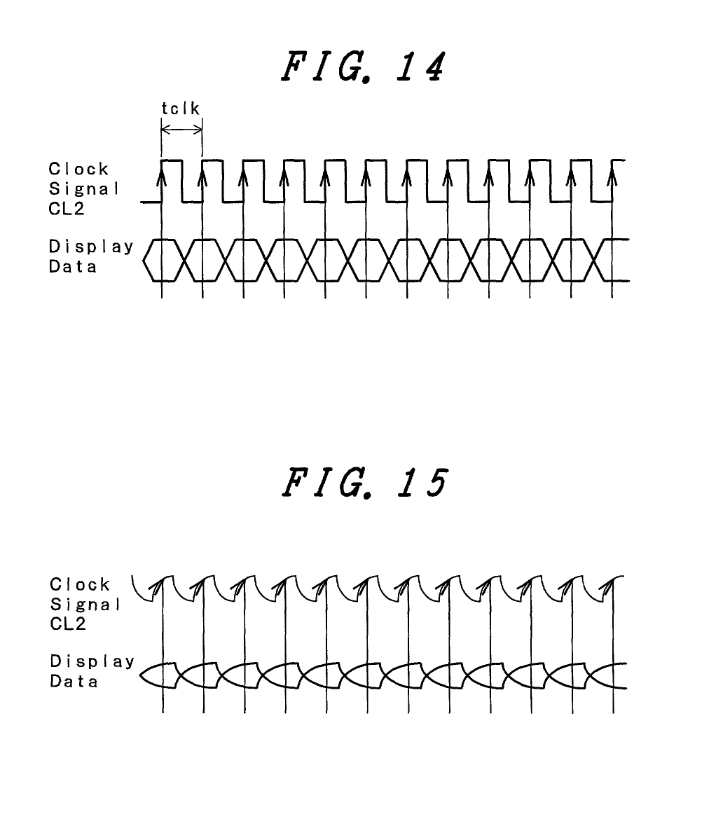

FIG. 14 is a view showing the output waveforms of display data DATA and the clock signal CL2 outputted to the circuit board 3 from the display control device 110 shown in FIG. 12.

The display data DATA are acquired into the drain drivers 130, for example, at the rise time of the clock signal CL2.

As described previously, as the liquid crystal display panel 100 is increased in size and resolution, the number of pixels per display line increases, so that the time required to acquire the display data DATA, i.e., the length of one period (tclk) of the clock signal CL2, is reduced.

Moreover, as the liquid crystal display panel 100 is increased in size and resolution, the longitudinal length of the circuit board 3 increases and not only do the internal parasitic capacitance 8, the internal resistance 9 and the internal inductance 10 increase, but also the number of the drain drivers increases, so that the input capacitance 11 also increases.

Consequently, the display data DATA and the clock signal CL2 having the output waveforms shown in FIG. 14 are outputted from the display control device 110, but the display data DATA and the clock signal CL2 having waveform distortions such as those shown in FIG. 15 are inputted to the input parts of the drain drivers 130.

In this manner, the drain drivers 130 cannot acquire predetermined data, and an erroneous picture is displayed on the liquid crystal display panel 100.

In addition, in the related art liquid crystal display module, the display data DATA and the clock signal CL2 are supplied to all of the bus line 13 and the signal line 14 of the circuit board 3, so that radiation electromagnetic noises radiated from the circuit board 3 increase.

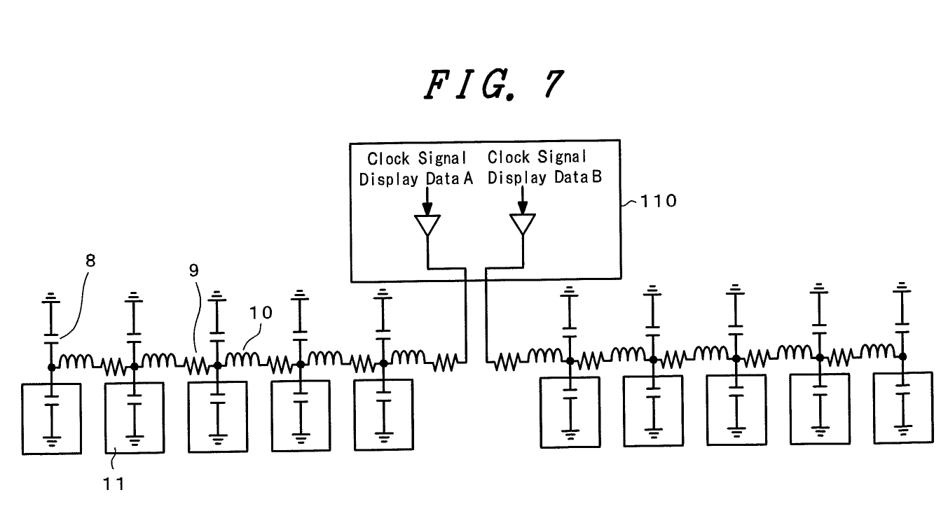

FIG. 7 is a view showing the equivalent circuit of the circuit board 3 according to Embodiment 1.

FIG. 8 is a view showing the output waveforms of the display data DATA and the clock signal CL2 outputted to the circuit board 3 from the display control device 110 of Embodiment 1.

As can be seen from FIG. 7, the bus line 13a and 13b and the signal line 14a and 14b of the circuit board 3 are divided into two groups, whereby the internal parasitic capacitance 8, the internal resistance 9 and the internal inductance 10 in each of the divided bus lines 13a and 13b and the divided signal lines 14a and 14b decrease to half as well as the input capacitances 11 of the drain drivers 130 decrease to half.

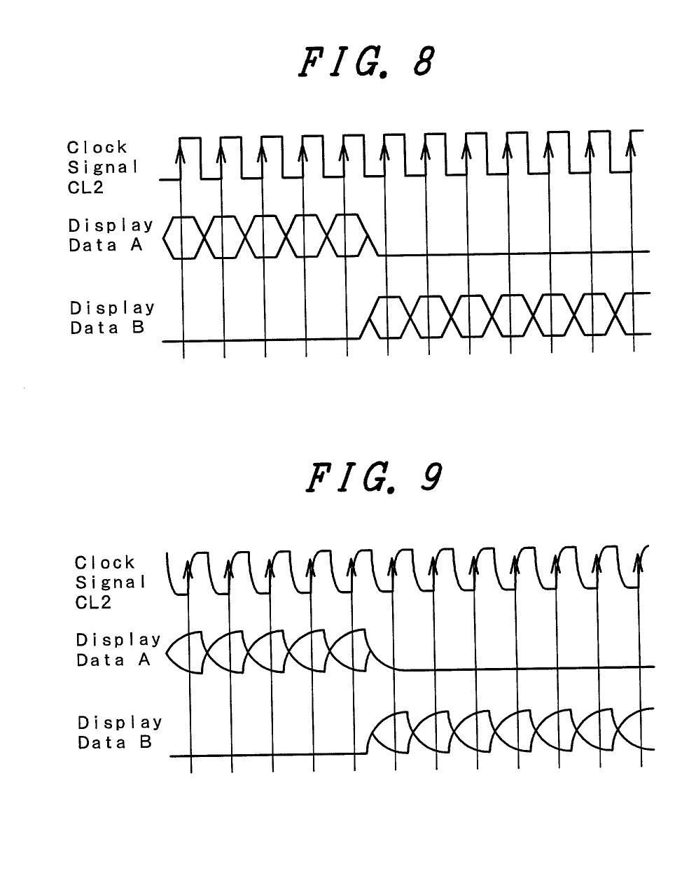

Therefore, the amounts of waveform distortions of the pulse-shaped signal waveforms of the display data DATA and the clock signal CL2 decrease to half, whereby the display data DATA and the clock signal CL2 which are reduced in waveform distortion as shown in FIG. 9 are inputted to the drain drivers 130. Accordingly, even if the period tclk becomes short, predetermined data can be acquired into each of the drain drivers 130.

Moreover, in Embodiment 1, in each of the longitudinal right and left halves of the circuit board 3, the display data DATA and the clock signal CL2 are not supplied during half of one horizontal scanning period, whereby the amount of radiation electromagnetic noise generated from the circuit board 3 can be reduced to ½ to decrease the amount of generation of radiation electromagnetic noise. Accordingly, it is possible to realize a low-noise liquid crystal display device.

In this manner, according to Embodiment 1, while the pulse-shaped display data DATA and clock signal CL2 is being transmitted from the display control device 110 to the drain drivers 130, the internal parasitic capacitance 8, the internal resistance 9 and the internal inductance 10 of the circuit board 3 in the transmission path as well as the input capacitance 11 of each of the drain drivers 130 can be reduced to ½.

Accordingly, even in the case of the high-resolution liquid crystal display panel 100 in which the transmission frequency of the display data DATA and the frequency of the clock signal CL2 are high, the internal parasitic capacitance 8, the internal resistance 9 and the internal inductance 10 as well as the input capacitance 11 can be reduced to ½, whereby a signal waveform having a predetermined amplitude and phase can be inputted to each of the drain drivers 130. Accordingly, it is possible to realize a high-resolution liquid crystal display device which is stable in driving.

In addition, in the two groups within the circuit board, one of which includes the bus line 13a and the signal line 14a and the other of which includes the bus line 13b and the signal line 14b, either of the two groups is supplied with the display data DATA and the clock signal CL2 from the display control device 110, while the other is supplied with a signal of fixed voltage level (for example, a low-level signal). Accordingly, it is possible to restrain the generation of radiation electromagnetic waves from ½ of the entire area of the circuit board 3, and it is possible to reduce the amount of generation of radiation electromagnetic noise.

[Embodiment 2]

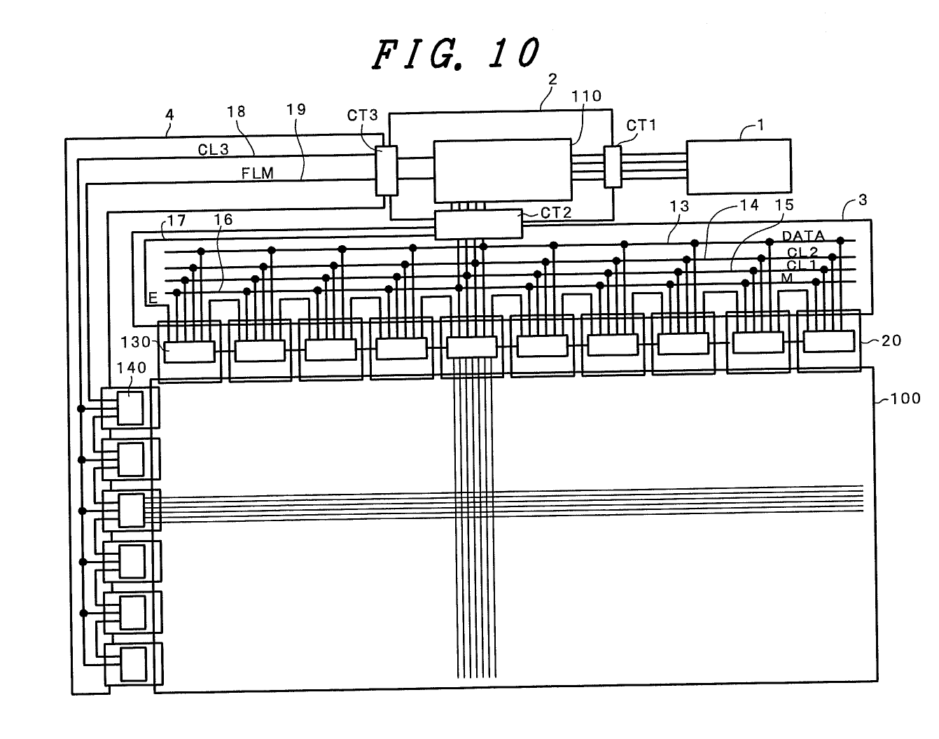

FIG. 10 is a block diagram showing the construction of each circuit board of a liquid crystal display module according to Embodiment 2 of the invention.

The liquid crystal display module of Embodiment 2 differs from that of Embodiment 1 in that each of the bus lines 13 and 14 of the circuit board 3 is made of a single signal line.

In Embodiment 2, the connector CT2 is disposed in the central portion of the circuit board 3.

Owing to this construction, in the case of the drain driver 130 which is the remotest from the connector CT2, the above-described internal parasitic capacitance 8, internal resistance 9, internal inductance 10 and input capacitance 11 are reduced to ½ compared to the related art liquid crystal display module shown in FIG. 12.

Therefore, even in Embodiment 2, the amounts of waveform distortions of the signal waveforms of the display data DATA and the clock signal CL2 can be decreased, and the display data DATA and the clock signal CL2 which are reduced in waveform distortion are inputted to the drain drivers 130. Accordingly, even if the period tclk becomes short, predetermined data can be acquired into each of the drain drivers 130.

The display control device 110 of Embodiment 1 requires two groups each including a display data output part and a clock signal output part for the clock signal CL2, but the display device of Embodiment 2 only needs one such group and therefore has the advantage that the circuit construction of the display control device 110 is simple.

However, in regard to the function of restraining the amount of generation of radiation electromagnetic noise, the liquid crystal display module of Embodiment 1 is superior to that of Embodiment 2.

[Embodiment 3]

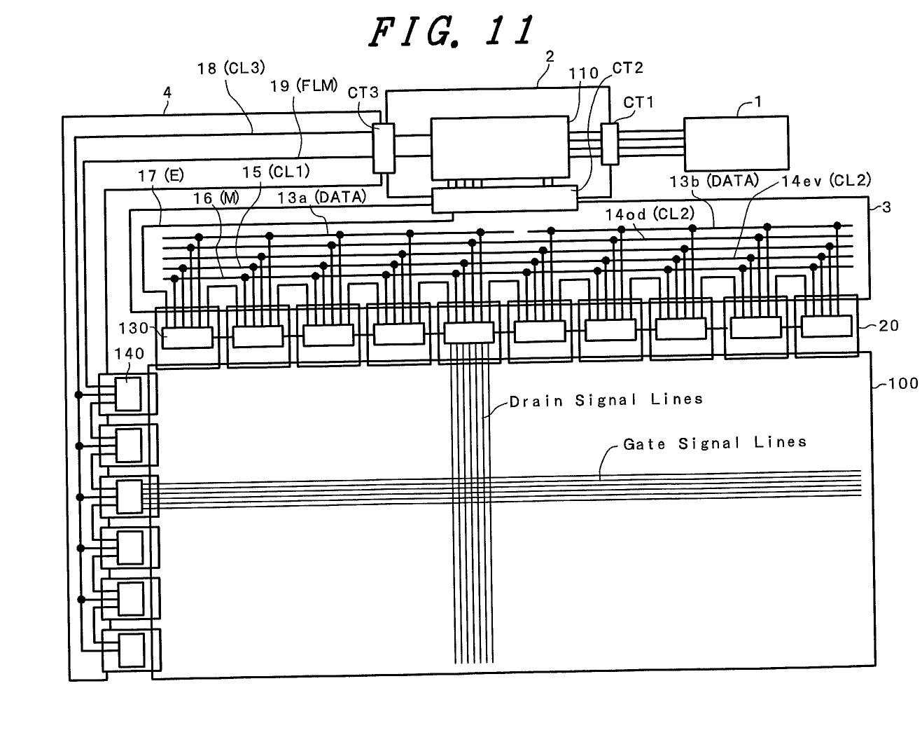

FIG. 11 is a block diagram showing the construction of each circuit board of a liquid crystal display module according to Embodiment 3 of the invention.

Embodiment 3 is a modification of Embodiment 1, and FIG. 11 is a view showing the construction of each circuit board in one modification of the liquid crystal display module of the invention described previously with reference to FIG. 6.

When the layouts of the drain-driver-side circuit boards 3 shown in FIGS. 11 and 6 are compared with each other, both layouts are common in that the bus line 13a and 13b through to transfer the display data DATA to each of the drain drivers 130 is separated into the right and left lines in the middle of the circuit board 3.

However, the shapes of two signal lines 14od and 14ev through which to transmit clock signals CL2 differ from those of the signal lines 14a and 14b provided on the circuit board 3 of FIG. 6 in that neither of the two signal lines 14od or 14ed is divided into the right and left lines on the circuit board 3 shown in FIG. 11 and the two signal lines 14od or 14ed have shapes extending in parallel along the longitudinal direction of the circuit board 3.

The ones of the drain drivers 130 that are respectively disposed at odd-numbered positions counted from the left side of FIG. 11 (hereinafter, the odd-numbered drivers 130) are connected to one (14od ) of the two signal lines disposed in parallel on the circuit board 3 shown in FIG. 11.

The ones of the drain drivers 130 that are respectively disposed at even-numbered positions counted from the left side of FIG. 11 (hereinafter, the even-numbered drivers 130) are connected to the other (14ev) of the two signal lines disposed in parallel on the circuit board 3 shown in FIG. 11.

During the display of a picture on the liquid crystal display panel 100, a gate signal is sent to each one of the plural gate signal lines G provided in this liquid crystal display panel 100, and gray scale voltages supplied to the respective drain signal lines D in correspondence relationship to these gate signal lines G (gray scale voltages based on display data) are supplied to the respective pixels provided in the liquid crystal display panel 100 (not shown in FIG. 11; refer to FIG. 2).

During the supply of the display data to each of the gate signal lines G, the plural drain drivers 130 are operated one by one from the one disposed on the left side of FIG. 11 in accordance with the pulse of the clock signals CL2, whereby the display data DATA are stored in the respective drain drivers 130.

In this case, the liquid crystal display panel driving period from the start of acquisition of display data into the drain driver 130 (disposed on the left end as viewed in FIG. 11) which corresponds to a certain gate signal line until the end of acquisition of display data into the drain driver 130 (disposed on the right end as viewed in FIG. 11) which corresponds to the same gate signal line is called “horizontal scanning period”.

In the case of the liquid crystal display module shown in FIG. 6, the clock signal CL2 is transmitted to the signal line 14a during the first half of the horizontal scanning period and to the signal line 14b during the second half of the same horizontal scanning period, whereby the display data DATA is acquired into each of the drain drivers 130 disposed in this liquid crystal display module.

In contrast, in the case of the liquid crystal display module shown in FIG. 11, during the horizontal scanning period, the clock signal CL2 is alternately transmitted to the two signal lines 14od and 14ev, and when the clock signal CL2 is transmitted to the signal line 14od , the display data DATA are respectively acquired into the odd-numbered drain drivers, while when the clock signal CL2 is transmitted to the signal line 14ev, the display data DATA are respectively acquired into the even-numbered drain drivers.

Accordingly, in either case, it is possible to reduce the number of drain drivers to be connected to each of the signal lines 14od and 14ev, and it is possible to restrain the waveform distortion of the clock signal CL2 transmitted from each of these signal lines 14od and 14ev.

Moreover, in the case of Embodiment 3 (FIG. 11), the operation of sequentially acquiring the display data DATA into the plural drain drivers 130 disposed in juxtaposition along the extending direction of the gate signal lines G is carried out by supplying the respective clock signals CL2 to mutually adjacent ones of these drain drivers 130 from the different signal lines 14od and 14ev. Accordingly, the frequency of the clock signal CL2 can be set to a low frequency (for example, ½ of the related art).

Accordingly, according to Embodiment 3, as compared with the above-described Embodiment 1, although the area of interconnection lines on the circuit board 3 becomes large, there is the advantage that the load to clock signal lines can be reduced.

Incidentally, the construction in which two or more (plural) signal lines are disposed to extend in parallel along the extending direction of the circuit board 3 and mutually adjacent ones of the drain drivers 130 are supplied with signals from different signal lines may be applied to not only the signal line 14 for the clock signal CL2 but also the bus line 13 for display data which changes in signal voltage at the same period as the signal line 14.

On the other hand, during a certain horizontal scanning period, the gray scale voltages corresponding to the display data DATA acquired in the drain drivers 130 are simultaneously supplied from the respective drain drivers 130 to the drain signal lines D connected to each of the drain drivers 130, in response to the pulse of the clock signal CL1 immediately before the end of the horizontal scanning period.

The polarity of the gray scale voltages to be supplied to the drain signal lines D in this manner is inverted during a predetermined horizontal scanning period or the like in response to the alternation signal M from the signal line 16.

In this manner, defective display due to polarization in a liquid crystal picture is restrained by periodically inverting the polarity of voltage to be applied to the liquid crystal layer.

In the case where a liquid crystal display device is driven at high speed as in a television set, its horizontal scanning period becomes considerably short.

In this case, the signal line 15 through which to transfer the clock signal CL1 varying at a period equal to or close to the horizontal scanning period or the signal line 16 through which to transfer the alternation signal M may be disposed in a similar form to the signal lines 14od and 14ev for the clock signal CL2 in Embodiment 3.

Incidentally, in the above description, reference has mainly been made to the case where the invention is applied to the bus line 13 and the clock signal line 14 of the circuit board 3, but the invention is not limited to this case, and can also be applied to another signal line of the circuit board 3 or a signal line of the circuit board 4.

In the description of each of the above-described embodiments, reference has been made to the case where the invention is applied to a vertical electric field type of liquid crystal display panel, but the invention is not limited to this case, and can also be applied to an In-Plane Switching mode of liquid crystal display panel.

In the description of each of the above-described embodiments, reference has been made to the case where the invention is applied to a TFT type of liquid crystal display device, but the invention is not limited to this case, and it goes without saying that the invention can also be applied to an STN type of simple matrix liquid crystal display device.

While the invention made by the present inventor has been specifically described on the basis of the embodiments of the invention, the invention is not limited to any of the above-described embodiments, and various changes and modifications can, of course, be made without departing from the gist of the invention.

The advantages of a representative aspect of the invention disclosed in the present application are summarized as follows:

(1) According to the liquid crystal display device of the invention, it is possible to decrease the amount of generation of radiation electromagnetic noise; and

(2) According to the liquid crystal display device of the invention, it is possible to accurately acquire display data into each driving circuit even in the case where a high-resolution liquid crystal display element is used.

What is claimed is:

1. A liquid crystal display device comprising:
a liquid crystal display element;
plural driving circuits;
a display control device which transmits display data and a clock signal to the plural driving circuits; and
a circuit board which is provided between the display control device and the plural driving circuits and supplies the display data and the clock signal transmitted from the display control device, to each of the driving circuits via a bus line and a clock line in the circuit board,
each of the bus line and the clock signal line of the circuit board being formed in a continuous area of the circuit board and being divided into plural lines.

2. A liquid crystal display device according to claim 1, wherein the display control device supplies the display data and the clock signal to each of the divided bus lines and clock signal lines in sequence in accordance with transmission timing.

3. A liquid crystal display device according to claim 2, wherein the display control device supplies a signal of fixed voltage level to each of the divided bus lines and clock signal lines to which the display data and the clock signal are not supplied.

4. A liquid crystal display device according to claim 1, wherein each of the bus line and the clock signal line of the circuit board is divided into two lines.

5. A liquid crystal display device according to claim 4, wherein the display control device sequentially supplies the display data and the clock signal to one of the bus lines and one of the clock signal lines and to the other of the bus lines and the other of the clock signal lines in sequence in accordance with transmission timing.

6. A liquid crystal display device according to claim 5, wherein while the display control device is supplying the display data and the clock signal to one of the bus lines and one of the clock signal lines, the display control device supplies signals of fixed voltage level to the other of the bus lines and the other of the clock signal lines.

7. A liquid crystal display device according to claim 4, wherein a connector for inputting the display data and the clock signal from the display control device is provided in a lengthwise central portion of the circuit board.

8. A liquid crystal display device according to claim 1, wherein the clock signal is a clock signal for latching display data.

9. A liquid crystal display device comprising:
a liquid crystal display element;
plural driving circuits;
a display control device which transmits display data and a clock signal to the plural driving circuits; and
a circuit board which is provided between the display control device and the plural driving circuits and supplies the display data and the clock signal transmitted from the display control device, to each of the driving circuits via a bus line and a clock line in the circuit board,
each of the bus line and the clock signal line of the circuit board being formed in a continuous area of the circuit board and being divided into plural lines, and a connector for inputting the display data and the clock signal from the display control device being provided in a portion other than a lengthwise end portion of the circuit board.

10. A liquid crystal display device according to claim 9, wherein the connector is provided in a lengthwise central portion of the circuit board.
